(19) United States
(12) Patent Application Publication
(10) Pub. No.: US 2026/0330362 A1
(43) Pub. Date: Oct. 22, 2026

(54) ARTIFICIAL INTELLIGENCE AGENT EXECUTION OF OPERATIONAL PLAYBOOKS AND RUNBOOKS

(71) Applicant: ServiceNow, Inc., Santa Clara, CA (US)

(72) Inventors: Yaron Lehmann, Sunnyvale, CA (US); Ramkumar Devanathan, Bengaluru (IN); Gabby Menahem, Santa Clara, CA (US)

(21) Appl. No.: 19/185,856

(22) Filed: Apr. 22, 2025

(51) Int. Cl. G06Q 10/0631

(52) U.S. Cl. CPC G06Q 10/06316

(57) ABSTRACT

Embodiments of the subject technology relate to systems, methods, and computer-readable media for autonomously executing a playbook through an agent. A playbook can be provided to an agent implemented through an LLM in a form that is perceivable by the LLM. The agent can be configured to exclusively execute the playbook according to instructions for resolving incidents through the playbook. An incident can be assigned to the agent. The agent can autonomously execute one or more resolution steps of the playbook based on the instructions to attempt to resolve the incident.

### BACKGROUND

### 1. Technical Field

The present disclosure generally relates to playbook development, and more specifically to inferring a playbook through a large language model (LLM).

### 2. Introduction

Playbooks have been developed that serve as a structured framework for visualizing and executing business processes. In one example field, in modern information technology (IT) environments, incidents such as system failures, and service disruptions are frequently encountered. Organizations often maintain large volumes of closed incident records, which contain valuable resolution knowledge. However, manually creating and updating a playbook, e.g. to avoid knowledge drift, from these incidents is time-consuming and error prone. Additionally, incident records are not uniform across different entities. Such discrepancies in incident records makes it difficult to create a playbook from the incidents across the different entities.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a diagram of an example cloud computing architecture, according to some examples of the present disclosure;

FIG. 1B is a block diagram illustrating an example network architecture that can be used to implement one or more embodiments, components, devices, nodes, systems, instances, and/or portions of the example cloud computing architecture, according to some examples of the present disclosure;

FIG. 2 illustrates a schematic diagram of an architecture 200 for performing incident resolution using a playbook, according to some examples of the present disclosure;

FIG. 3 illustrates a flowchart 300 of an example method of autonomously executing a playbook through an agent implemented by an LLM, according to some examples of the present disclosure;

FIG. 4 illustrates a flowchart 400 of an example method of autonomously escalating an incident through an agent implemented through an LLM, according to some examples of the present disclosure;

FIG. 5 illustrates a flowchart 500 of an example method of autonomously performing operations through an agent in implementing a playbook to attempt to resolve an incident, according to some examples of the present disclosure;

FIG. 6 illustrates a flowchart 600 of an example method of an autonomous agent analyzing execution of a playbook and making modifications to the playbook or instructions for executing the playbook, according to some examples of the present disclosure;

FIG. 7 is an example of a deep learning neural network that can be used to implement all or a portion of the systems and techniques described herein, according to some examples of the present disclosure;

FIG. 8 is a diagram illustrating an example architecture of an example transformer model, according to some examples of the present disclosure; and

FIG. 9 illustrates an example processor-based system with which some embodiments of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

In modern IT environments, incidents such as system failures, and service disruptions are frequently encountered. Organizations often maintain large volumes of closed incident records, which contain valuable resolution knowledge. In turn, playbooks have been developed based on closed incident records to help in resolving future incidents. A playbook can be created based on an applicable occurrence and objective defined in relations to the occurrence, such as an incident with a resolution. Specifically, human operators can implement playbooks that are developed from incident records to resolve future incidents.

Organizations have developed structures for responding to incidents. Specifically, hierarchical organizational structures have been developed for responding to incidents based on the complexity and severity of such incidents. An example hierarchical structure includes three levels of operators (1, 2, and 3). In this example structure, Level 1 operators can handle simple and frequently occurring incidents. For example, a level 1 operator can implement a runbook specifying a sequence of steps in a specific order without any decision points to follow in resolving an incident. Further, Level 2 operators can handle more complex incidents that can require specialized knowledge and experience to address the incidents. For example, a level 2 operator can implement a playbook to troubleshoot and resolve more complex incidents, e.g. in comparison to incidents addressed by level 1 operators. Level 3 operators can handle incidents that are critical and/or beyond the scope of level 1 and level 2 operators. Specifically, an incident can be escalated to a level 3 operator who is a subject matter expert in association with the circumstances of the incident. In turn, the level 3 operator can attempt to resolve the incident or work with lower operators to resolve the incident.

Executing playbooks can be intensive from an operator resource perspective. Specifically human operators can be slow in resolving incidents through a playbook, fail to adhere to playbook and policy (e.g., communication style), and process (e.g., documenting resolution notes). However, executing playbooks can be a difficult process to automate efficiently and accurately. Specifically, while some steps in a playbook can be repetitive, it can be difficult to automate all or a portion of the playbook (and corresponding decision points in the playbook) so that that playbook is correctly implemented. Even if the playbook can be automated, the automation may expend excessive time and resources.

Further, automating playbooks within an organizational structure have additional complications. Specifically, organizations may have one or more specific rules for escalating the incidents within a hierarchy of the organization. For example, rules can specify that at certain points within a playbook, a level 2 operator should elevate an incident to a level 3 operator. However, ensuring that an autonomous agent will correctly escalate an incident at the correct point while running a playbook can be difficult to achieve with precision. In turn, incident resolution can be slowed while failing to adhere to the playbook and policy in attempting to autonomously resolve an incident when the incident should be escalated to a higher level, e.g. level 3 operator.

The disclosed technology addresses the foregoing by configuring an agent implemented through a large language model (LLM) to autonomously execute a playbook according to instructions for resolving incidents. In turn, the agent can autonomously execute the playbook to resolve received incidents. By leveraging agents to autonomously execute the playbook, an organization can conserve resources that would otherwise be spent on a human operator implementing the playbook to resolve the incident.

In some implementations, the instructions specify how the incident is to be escalated during the course of running the playbook for incident resolution. In these implementations, the incident is autonomously escalated in a precise manner, thereby conserving resources that would otherwise be wasted in continuing to resolve the incident without escalation.

Further, agents may be configured to exclusively execute a specific playbook. In particular, the agent can be configured to only execute the specific playbook while refraining from executing, or otherwise not be configured to execute, other playbooks in resolving incidents. Accordingly, the agent can effectively become an expert in running the specific playbook across different incidents. As follows, the agent can analyze the results of running the specific playbook across the different incidents and refine either or both the specific playbook and the instructions for resolving incidents through the specific playbook based on the results. Refinement can comprise adding/changing/removing content, e.g. adding a step. Further, refinement can comprise rearranging and optimizing the flow of the existing playbook. The analysis and refinement can be done in an autonomous manner, thereby conserving human resources

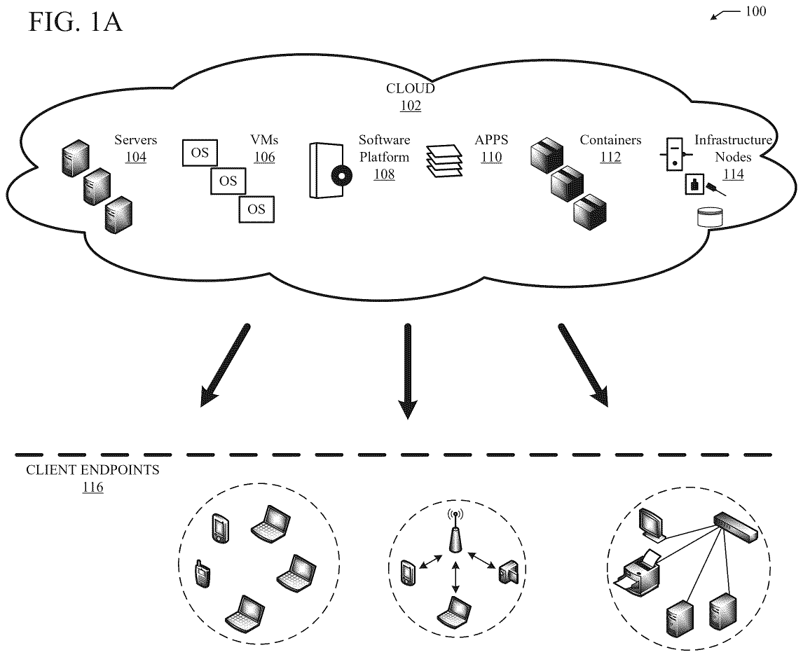

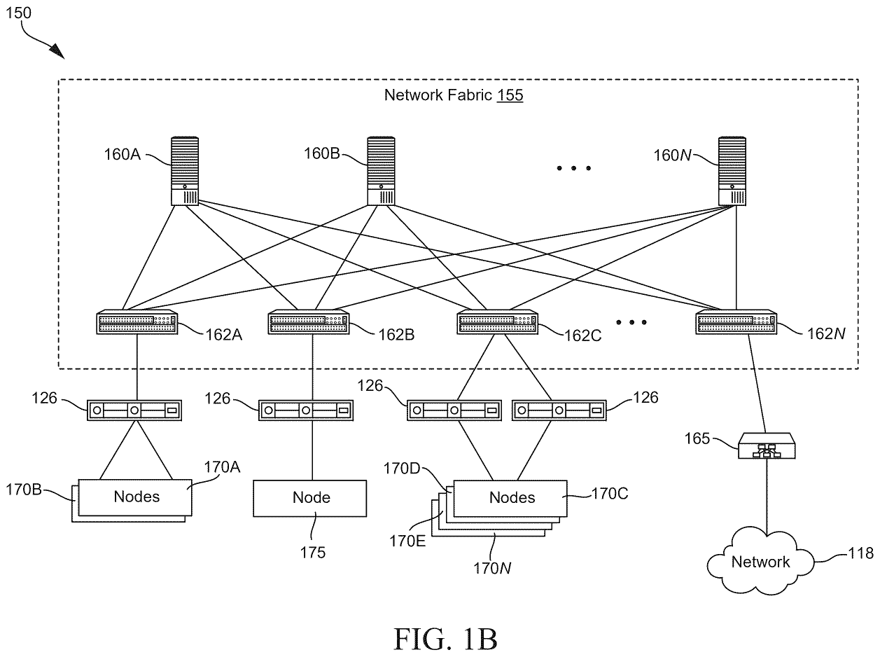

FIG. 1A illustrates a diagram of an example cloud computing architecture 100. The architecture can include a cloud 102. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can provide various cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, or any smart or connected object (e.g., smart home, smart building, smart retail, smart glasses, etc.), and so forth.

In some cases, one or more embodiments, components, devices, nodes, systems, instances, and/or portions of the example cloud 102 can be implemented by and/or in a cloud network or datacenter. For example, any portion (or all) of the network 118, any of the content servers 120 (or all), and/or any of the system servers 126 (or all) can be implemented by and/or in a cloud network or datacenter. An example network architecture that can be used to implement any such network or datacenter (or any portion thereof), is shown in FIG. 1B and further described below.

FIG. 1B is a block diagram illustrating an example network architecture 150 that can be used to implement one or more embodiments, components, devices, nodes, systems, instances, and/or portions of the example cloud computing architecture 100, according to some examples of the present disclosure. The example network architecture 150 in FIG. 1B can represent, implement, deploy, host, support, include and/or provide the infrastructure for (or a portion of the infrastructure for) a datacenter (e.g., a cloud datacenter, an on-premises datacenter, a hybrid datacenter including private and public datacenters or datacenter portions, etc.), a network infrastructure, and/or any network environment (or portion thereof) such as, for example and without limitation, a cloud network/environment, a campus network/environment, an enterprise network/environment, an on-premises network/environment, a private network/environment, a public network/environment, a hybrid network/environment (e.g., a network/environment including both private and public networks/environments or portions thereof), and/or the like.

In some examples, the example network architecture 150 can host, implement, deploy, provide (e.g., provide the infrastructure for or a portion of the infrastructure for), support, and/or run/execute one or more applications, virtual machines (VMs), software containers, software tools, software functions, software algorithms, software models (e.g., artificial intelligence and machine learning models, software models implementing one or more classical algorithms, etc.), software applications, software packages, domains, databases, networks, services, workloads, service chains, functions, controllers, virtual network functions (VNFs), servers, drivers, hardware and/or software resources, software and/or hardware devices, software and/or hardware nodes, networking elements, serverless environments, serverless functions, cloud services and/or applications (e.g., software-as-a-service, function-as-a-service, infrastructure-as-a-service, platform-as-a-service, cloud applications, and/or any other cloud services and/or applications), execution environments, storage systems, processing/compute systems, memory systems, software and/or network sites, software policies, virtual/logical networks, overlay networks, software-defined networks (SDNs), interfaces, and/or any other code, component, element, application, service, etc.

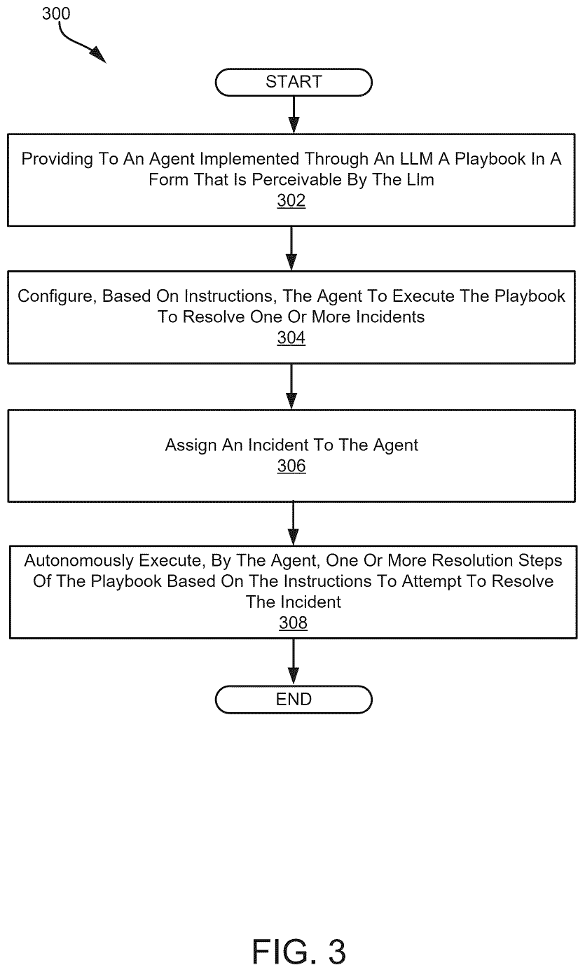

For example, the network architecture 150 can include, represent, implement, support, run, host, and/or provide the infrastructure for (or a portion of the infrastructure for) a datacenter, network (e.g., a cloud or cloud network, an on-premises network, a private network, a public network, a hybrid network, etc.), network infrastructure, and/or network environment used to host, implement, support, deploy, provide, and/or run quality control workloads/nodes, such as the worker nodes and the master node shown in FIG. 3 (and further described below). In such examples, the master node and each of the worker nodes can implement, include, represent, support, run, host, and/or provide one or more software applications/services, software systems, software packages, software modules, software units, software tools, interfaces, software/application code, functions, virtual environments, virtual applications, execution environments, virtualization elements (e.g., operating system-level virtualization elements, application-level virtualization elements, etc.), platforms, and/or any other components. In some cases, the master node and/or one or more of the worker nodes (or all) can each host and run one or more software containers, VMs, VNFs, applications (e.g., container applications, VM applications, and/or any other software applications), operating systems (OSs), functions, tools, and/or any other execution environment, code, tool, component, element, and/or package.

As shown in FIG. 1B, the network architecture 150 can include a network fabric 155. The network fabric 155 can include and/or represent the physical layer (e.g., underlay) and/or infrastructure of the network architecture 150. In some cases, the network fabric 155 can represent a data center(s) of one or more networks such as, for example, one or more cloud networks. The network fabric 155 can include network devices 160A-N (collectively referred to as “network devices 160” hereinafter) and network devices 162A-N (collectively referred to as “network devices 162” hereinafter), which are interconnected to route, relay, forward, and/or switch traffic in the network fabric 155. In some examples, the network devices 160 and the network devices 162 can include, implement, represent, and/or operate as switches (e.g., Layer 2 and/or Layer 3 switches, aggregation switches, ingress and/or egress switches, top-of-rack (ToR) switches, core switches, spine switches, leaf switches, etc.), routers, hubs, bridges, gateways, provider edge devices, firewalls, network controllers, and/or any other type of networking devices. In FIG. 1B, the network fabric 155 includes or implements a spine-leaf topology. In such examples, the network devices 160 can represent spine nodes (e.g., spine switches or routers) and the network devices 162 can represent leaf nodes (e.g., leaf switches or routers). In other examples, the network fabric 155 can alternatively or additionally include or implement any other network topology.

The network devices 160 are interconnected with the network devices 162, and the network devices 162 can connect the network 118, the system servers 126 (e.g., including QC system(s) 130 and configuration system(s) 132), the network device 165, the nodes 170, and/or the node 175 with any portion of the network fabric 155 (e.g., including each other), the media device(s) 106, the content servers 120, an external network(s), a network overlay(s), a logical network(s), a network portion(s) or branch/branches, an external device(s), a service chain(s), a data center(s), a cloud network(s), and/or any other network(s) and/or compute/network element(s). In some cases, the network fabric 155 can include, host, and/or implement a network overlay(s) or logical network(s) that includes or implements one or more application services, servers, VMs, software containers, virtual resources (e.g., storage, memory, processors, network interfaces, virtual tools, execution environments, etc.), workloads, functions, virtual networks, hardware and/or software resources, and/or any other element(s).

Network connectivity in the network fabric 155 can flow from the network devices 160 to the network devices 162, and vice versa. The network devices 162 can route, switch, relay, forward, and/or bridge network traffic to and from other portions of the network fabric 155, other networks, e.g. network 118, various network elements, the network device 165, the nodes 170, the node 175, external client devices (e.g., clients devices external to the network fabric 155), data centers, clouds, tunnels, software-defined networks (SDNs) and/or SDN branches, on-premises networks, cloud tenants, cloud customers, applications, and/or any other network element. Thus, the network devices 162 can connect networks and network elements of the network fabric 155 with each other and with other networks and network elements.

In FIG. 1B, the system servers 126 can include or represent computer servers. Each of the system servers 126 can host, include, implement, and/or run one or more applications, functions, services, VMs, software containers, service chains, workloads, AI/ML models, algorithms, resources, cloud appliances, and/or any other software. In some cases, the system servers 126 connected to the network devices 162 can encapsulate and decapsulate packets to and from the network devices 162. For example, the system servers 126 can include, host, implement and/or operate one or more virtual routers, switches, gateways, endpoints, and/or network devices for tunneling packets between an overlay or logical layer hosted by, or connected to, the system servers 126 and an underlay layer represented by or included in the network fabric 155.

As shown in FIG. 1B, the system servers 126 can host, include, run, operate, and/or implement the nodes 170 and the node 175. In some examples, the nodes 170 and the node 175 can represent cloud instances. For example, in some cases, the nodes 170 and the node 175 can each represent a virtual server and/or environment (e.g., a VM, a software container, etc.) that uses compute, memory, storage, and/or networking resources on the cloud (e.g., network architecture 150) for respective workloads. In some embodiments, the nodes 170 and/or the node 175 can perform parallel computing using, for example, multithreading. Each of the nodes 170 and/or the node 175 can include, host, implement, run, operate, and/or represent one or more server applications, software containers, VMs, software, services, AI/ML models, algorithms, cloud appliances, software functions, service chains, workloads, server-side functions, processing resources, computers, and/or any other software and/or hardware component.

For example, in some cases, each of the nodes 170 and/or the node 175 can represent a node instance that includes, implements, hosts, and/or runs a software container(s). The software container associated with a node can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). In some cases, the nodes 170 and the node 175 can represent cloud node instances running respective computing environments, such as software containers or VMs. Each VM can include software, services, drivers, applications, libraries, functions, virtualized resources (e.g., processors, memory, storage, network interfaces, etc.), and/or workloads installed, implemented, included, and/or running/executed on a guest operating system (OS) associated with the VM.

The network architecture 150 can deploy, run, implement, host, and/or support various resources (e.g., hosts, applications, services, functions, VMs, software containers, workloads, cloud appliances, service chains, hardware and/or software resources, AI/ML models, algorithms, application platforms, operating systems, etc.) using the system servers 126, the network fabric 155, the network devices 160, the network devices 162, the network device 165, the nodes 170, the node 175, and the network 118.

In some cases, the network architecture 150 can implement and/or can be part of one or more cloud networks and can provide one or more cloud computing services such as, for example and without limitation, cloud storage, serverless computing, software-as-a-service (SaaS) (e.g., streaming services, content delivery services, video services, Internet content services, application services, conferencing services, etc.), infrastructure-as-a-service (IaaS), platform-as-a-service (PaaS) (e.g., web services, streaming services, content delivery services, content library services, conferencing services, video services, Internet content services, sharing and/or collaboration services, etc.), function-as-a-service (FaaS), and/or any other types of services such as desktop-as-a-service (DaaS), information technology management-as-a-service (ITaaS), managed software-as-a-service (MSaaS), mobile backend-as-a-service (MBaaS), etc.

The network architecture 150 described above illustrates a non-limiting example network architecture provided herein for explanation purposes. It should be noted that other network architectures can be implemented in other examples and are also contemplated herein. One of ordinary skill in the relevant art(s) will recognize in view of the disclosure that other network architectures can be used to implement one or more of the concepts, systems, techniques, devices, software, applications, methods, embodiments, elements, examples, and/or components disclosed herein.

Various embodiments of the subject technology can be implemented through the cloud computing architecture 100 shown in FIG. 1A and the network architecture 150 shown in FIG. 1B. In particular, machine learning (ML) models and large language models (LLMs) and other applicable models and applications can be implemented through the architectures 100 and 150.

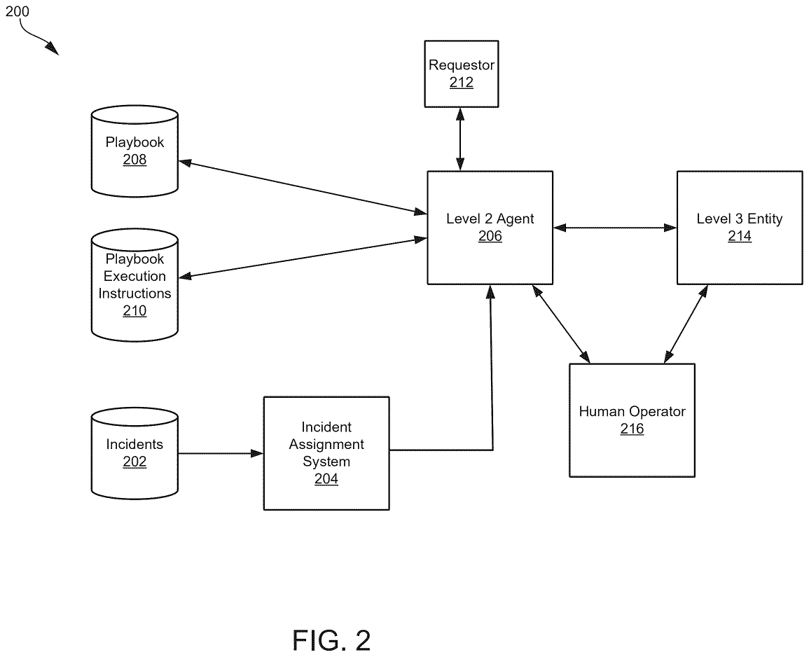

FIG. 2 illustrates a schematic diagram of an architecture 200 for performing incident resolution using a playbook, according to some examples of the present disclosure. The architecture 200 comprises an incidents datastore 202, an incident assignment system 204, a level 2 agent, a playbook datastore 208, a playbook execution instructions datastore 210, a requestor 212 a level 3 entity 214, and a human operator 216.

The incidents datastore 202 can store information related to incidents occurring in relation to the architecture 200. Specifically, the incidents datastore 202 can store information related to past incidents and current incidents. Incidents can have varying occurrence rates. An incident can be a unique incident with a low chance of occurring again. For example, an incident can be a unique attack launched against an enterprise. Alternatively, an incident can be a frequently occurring incident. For example, an incident can be a routine problem associated with accessing an email account. An incident can either have a resolution or not have a resolution. A resolution to an incident, as used herein, can include fixing a disruption, e.g. to a service or infrastructure, as part of the incident. A resolution to an incident, as used herein, can also include achieving a state in response to a disruption that is acceptable to a controlling authority. For example, a resolution to an incident can be that the disruption has been eliminated and any effects caused by the disruption have been remedied.

The incident assignment system 204 functions to assign incidents to an entity, e.g. level 2 agent 206, for resolution through the entity. Specifically, the incident assignment system 204 can assign a current incident to the level 2 agent 206. The level 2 agent can then implement a playbook in attempting to resolve the incident.

The incident assignment system 204 can assign incidents according to assignment rules. Assignment rules can specify applicable rules for assigning an incident to an entity for resolution. Specifically, assignment rules can specify applicable rules for assigning an incident to an entity based on characteristics of the incident, such as an incident type, parties involved in the incident, a requestor seeking to resolve the incident, and other applicable characteristics. Further, assignment rules can specify applicable rules for assigning an incident to an entity based on a playbook that is implemented by the entity. For example, if a specific type of playbook have been used in resolving a specific type of incident, and an agent implemented the specific type of playbook, then incidents of the specific type can be assigned to the agent.

As will be discussed in greater detail later, the level 2 agent 206 can be configured to act as an expert for resolving one particular type of incident. For example, the system can keep track of frequently occurring incidents (i.e., a routine problem associated with accessing an email account, among others) and keep a record in incidents database 202. In some examples, each incident type can be recorded and stored in incidents database 202 regardless of whether it is determined to be a frequently occurring incident. When the system encounters an incident more than a predetermined threshold number of times over a certain period of time, that incident can be considered a frequent incident. Incident assignment system 204 can then assign one of the one or more level 2 agents 206 to handle requests directed to a specific incident.

The playbook datastore 208 functions to store data used in implementing a playbook. A playbook, as used herein, can comprise a plurality of stages to follow in achieving a resolution for an incident. The stages can be related and traversed in a specific order in achieving the resolution for the incident. For example, a playbook can comprise a stage for identifying a cause of an incident, a stage for containing the cause of the incident, and a stage for remedying changes caused by the incident. In another example, a playbook can comprise a stage of interacting with a customer to identify an IT issue and a stage of remedying the IT issue. In various embodiments, a playbook can correspond to an incident or a type of incident. For example a playbook can comprise steps for resolving a specific IT issue. In another example, a playbook can comprise steps for resolving a broad category of IT issues that are all the same type of IT incident.

Stages in a playbook can be formed through workflows, otherwise subflows, that form the playbook. In various embodiments, only a subset of the stages/workflows can be traversed in executing the playbook to attempt to achieve the objective of the playbook. Specifically, the stages/workflows can be organized in a hierarchical structure, e.g. tree structure. More specifically, the stages can form one or more branches in the hierarchical structure that can be traversed along a specific traversal path in attempting to achieve the object of the playbook. The traversal path can exclude specific stages/workflows such that the stages/workflows are not run when executing the playbook according to the traversal path.

Only a subset of the stages can be traversed in achieving the resolution for the incident. Specifically, the stages can be organized in a hierarchical, e.g. tree structure. More specifically, the stages can form one or more branches in the hierarchical structure that can be traversed in attempting to resolve an incident according to the playbook. In various embodiments, only certain stages are executed in the hierarchical structure in resolving an incident.

A hierarchical structure of a playbook can comprise different conditional actions, otherwise referred to as resolution steps, and corresponding conditions that guide completion of the actions. Specifically, each stage/workflow in the hierarchical structure can comprise different conditional actions and corresponding conditions that cause performance of one or more of the conditional actions in starting, executing, or otherwise completing the stage/workflow of the playbook. The conditional actions can form different stages, e.g. branches, in the hierarchical structure and corresponding conditions can guide which stages/workflows, corresponding to the conditional actions, are performed in traversing the hierarchical structure. For example, a playbook can comprise a conditional action that if met causes performance of a specific stage/subflow within the playbook. Different stages/workflows of the hierarchical structure can be traversed based on whether corresponding conditions of the conditional actions that form the stages are met or not. Specifically, nodes in the hierarchical structure can comprise decision points to determine whether a condition has been met. In turn, a specific stage/workflow of the hierarchical tree that is connected to the node, or otherwise includes the node, can be traversed based on whether the condition has been met. For example, branch A that corresponds to a first stage/workflow and is connected to a node can be traversed if the condition is met. Further in the example, branch B that corresponds to a second stage/workflow and is connected to the node can be traversed if the condition is not met.

A stage of a playbook can comprise a workflow. As follows, a hierarchical structure of the playbook can comprise a plurality of workflows. The workflows can be connected at decision points to form the hierarchical structure of the playbook. The decision points can include or be associated with conditional actions that are used to guide which playbooks are run in traversing the hierarchy. Accordingly, certain workflows in the playbook will be run in executing the playbook while other workflows will not be run in executing the playbook.

A playbook can comprise an automated action. An automated action can comprise an action that is capable of being performed/is performed by a system other than a human in executing a playbook. For example, an automated action can be performed by an agent in executing the playbook in attempting to achieve an objective. Further, a playbook can comprise a manual action. A manual action can comprise an action that is capable of being performed/is performed by a human operator in executing a playbook. Automated and manual actions can be trigger-specific actions that form part of a stage/workflow in a hierarchical structure of a playbook.

While the technology is described in this disclosure with respect to incidents, in various embodiments, the technology can be practiced with respect to other applicable occurrences, such as changes and alerts. For example, the technology can be applied to repetitive workflow occurrences. Further, technology described herein can be practiced in other applicable domains outside of incident resolution, such as marketing operations, financial operations, and legal operations.

As illustrated in FIG. 2, a requester 212 can communicate with an agent (e.g., level 2 agent 206) when the requester 212 encounters an incident that the requester 212 would like resolved. In some examples, requester 212 can directly contact a level 2 agent 206 upon encountering one or more incidents that need resolution. In other examples, the architecture 200 can direct the requester 212 to communicate with the level 2 agent 206 based on assignment of the incident to the level 2 agent by the incident assignment system 204. Specifically, in some cases the system 200 can include multiple level 2 agents 206, wherein each of the level 2 agents 206 can be customized to act as an expert for resolving one particular type of incident. In some examples, requester 212 can alternatively be directed to a level 1 agent (not shown in FIG. 2). For example, incidents that can be considered routine incidents (i.e., a user forgetting a password) can typically be resolved by a level 1 agent while incidents that can be considered more complex can be resolved by a level 2 agent 206 (or, in some cases, as explained in more detail below, a level 3 entity 214).

The level 2 agent 206 can be customized to act as an expert for resolving a particular type of incident. For example, the system can keep track of frequently occurring incidents (i.e., a routine problem associated with accessing an email account, among others) and keep a record in incidents database 202. In some examples, each incident type can be recorded and stored in the incidents database 202 regardless of whether it is determined to be a frequently occurring incident. When the system encounters an incident more than a predetermined threshold number of times over a certain period of time, that incident can be considered a frequent incident. Incident assignment system 204 can then assign the level 2 agent 206 to handle requests directed to a specific incident. In some examples, more than one level 2 agent 206 can be assigned to handle a specific incident. In other examples, a single level 2 agent 206 can act as an expert for more than one incident type. Alternatively, one or more level 2 agents 206 can act as generalized agents that can attempt to handle any type of incident. Therefore, as shown in FIG. 2, when a requester 212 communicates an incident request to a level 2 agent 206, the level 2 agent assigned to handle the incident request can be a level 2 agent 206 that has been designated and/or trained as an expert on resolving the particular incident.

The level 2 agent 206 can function to implement a playbook in resolving an incident. The level 2 agent can exclusively implement the playbook. Exclusively implementing a playbook, as used herein, can include that the agent implements the playbook without implementing any other playbooks. By only implementing a single playbook, the agent can effectively become an expert at resolving incidents with the playbook.

Each type of incident can be associated with a particular playbook (e.g., playbook 208) that can assist with resolving the incident and the level 2 agent 206 can access the playbook 208 as illustrated in FIG. 2. Specifically, the level 2 agent can be assigned an incident based on the playbook that is executed by the level 2 agent 206 and the incidents can be resolved through the playbook. In turn, upon receiving an incident request from requester 212, the level 2 agent 206 can access the playbook. In order to attempt to resolve the incident, level 2 agent 206 can access playbook execution instructions 210 for implementing the playbook to resolve the incident. In turn, the agent 206 can implement the playbook execution instructions 210 in implementing the playbook to attempt to resolve assigned incidents.

Playbook execution instructions, as used herein, can comprise applicable instructions that can be followed by an agent in implementing a playbook to attempt in resolving an incident. Specifically, instructions can specify information that can be obtained and used in resolving an incident through a playbook. For example, playbook execution instructions can specify to access a detailed playbook, incident data of an incident, and tools or separate knowledge sources in attempting to resolve an incident. Tools or separate knowledge sources can comprise applicable sources separate from the playbook that can be used in gathering or generating information that can be used in resolving an incident through a playbook. For example, instructions can specify gathering information with a requestor associated with an incident, interact with a human operator that is separate from the requestor, interact with another entity, e.g. an agent or operator at a higher level in an organizational structure, or access a knowledgebase that is separate from the agent, e.g. separate from an enterprise associated with the agent. For example, instructions can specify querying an external knowledgebase from the agent, e.g. through retrieval-augmented generation, in implementing the playbook.

Playbook instructions can also specify how to implement the playbook, e.g. according to accessed information or communication with a specific entity. Specifically, the playbook instructions can instruct an agent to execute a playbook so that the time to resolution is minimized, otherwise execute the playbook to achieve the resolution as fast as possible. Further, instructions can instruct an agent to minimize contact with a requestor associated with an incident, otherwise execute a playbook with as little interaction with the requestor as possible. Additionally, instructions can instruct an agent to communication with a human operator, the requestor, or another agent as needed to either escalate or resolve an incident.

The level 2 agent 206 can comprise and be implemented through one or more applicable generative machine learning (ML) models, such as large language models (LLMs) to resolve incidents. Specifically, once level 2 agent 206 receives an incident request from requester 212, it can access playbook 208 and playbook execution instructions 210 and attempt to resolve the incident by executing the playbook 208 according to the instructions 210. For example, the level 2 agent 206 can execute the playbook 208 in the quickest time possible and using the various tools and knowledge sources that are accessed according to the instructions 210.

In being implemented through one or more generative ML models, the level 2 agent 206 can execute the playbook 208 and playbook execution instructions 210 autonomously. In acting as an autonomous agent, the level 2 agent can make decision and take actions to achieve a resolution to an incident without direct human intervention. Specifically, the level 2 agent can operate the instructions to implement a playbook without direct human intervention in executing the instructions. As used herein, an agent refers to an autonomous system that is implemented through one or more ML models, such as an LLM. Further and as used herein, an operator refers to an entity that is a human or a system that is controlled directly by a human, e.g. does not operate autonomously.

The level 2 agent 206 can be trained to understand any specific implementation of the playbook execution instructions 210 and can use various tools to advance the playbook 208 and record any decisions made. In turn and as will be discussed in greater detail later, level 2 agent 206 can learn from each incident it attempts to resolve to improve its performance in implementing the playbook 208 over time. Specifically, the level 2 agent 206 can update either or both the playbook 208 and the playbook execution instructions 210. In various embodiments, the playbook 208 and the playbook execution instructions 210 that are updated by the level 2 agent 206 can be shared with other level 2 agents implementing the playbook 208. Alternatively, only the instances of the playbook 208 and the playbook execution instructions 210 that are implemented by the level 2 agent can be updated such that changes made to the playbook 208 and/or the playbook execution instructions 210 are only implemented by the level 2 agent 206 that made the changes.

The disclosure now continues with a discussion of a method of automating playbook execution through an agent. Specifically, FIG. 3 illustrates a flowchart 300 of an example method of autonomously executing a playbook through an agent implemented by an LLM, according to some examples of the present disclosure. The method shown in FIG. 3 is provided by way of example, as there are a variety of ways to carry out the method. Additionally, while the example method is illustrated with a particular order of steps, those of ordinary skill in the art will appreciate that FIG. 3 and the modules shown therein can be executed in any order and can include fewer or more modules than illustrated. Each module shown in FIG. 3 represents one or more steps, processes, methods or routines in the method. The modules will be discussed with respect to the example architectures described herein.

At module 302, a playbook is provided to an agent, (e.g., level 2 agent 206) implemented through an LLM, in a form that is perceivable by the LLM. Specifically, the actual playbook itself can be provided to the agent. Further, instructions for implementing the playbook to resolve incidents can be provided to the agent. For example and as discussed above, the level 2 agent 206 can comprise and execute generative ML models, such as LLMs to implement the playbook and attempt to resolve incidents through the playbook.

At module 304, the agent (e.g., level 2 agent 206) is configured, based on instructions, to execute the playbook to resolve one or more incidents. Specifically, the agent can be configured to implement the instructions in executing the playbook to resolve an incident according to resolution steps included in the playbook. For example and as discussed previously, the playbook instructions can instruct the agent to execute the playbook so that the time to resolution is minimized, otherwise execute the playbook to achieve the resolution as fast as possible. In another example, the instructions can instruct the agent to minimize contact with a requestor associated with the incident, otherwise execute the playbook with as little interaction with the requestor as possible.

The instructions can direct the agent to access and utilize various tools or separate knowledge sources in gathering information and performing functions for implementing the playbook to resolve the incident. Specifically, the agent can be configured to interact with a requestor associated with the incident, interact with a human operator that is separate from the requestor, interact with another entity, e.g. an agent or operator at a higher level in an organizational structure, or access a knowledgebase that is separate from the agent, e.g. separate from an enterprise associated with the agent. For example, instructions can specify consulting with a separate human operator in trying to implement the playbook. As follows, the agent can be configured to ask or otherwise consult with the human operator, e.g. when the agent is unable to complete a resolution step of the playbook.

The playbook comprises a plurality of stages to follow in achieving an objective for a specific occurrence, e.g. a resolution for an incident or performing an operation based on updating of specific data in a record. The stages can be related and traversed in a specific order in achieving the resolution for the incident. For example, playbook execution instructions 210 can comprise a stage for identifying a cause of an incident, a stage for containing the cause of the incident, and a stage for remedying changes caused by the incident. In another example, a playbook can comprise a stage of interacting with a customer to identify an IT issue and a stage of remedying the IT issue. In various embodiments, each playbook 208 can correspond to an incident or a type of incident. For example, playbook execution instructions 210 can comprise steps for resolving a specific IT issue. In another example, playbook execution instructions 210can comprise steps for resolving a broad category of IT issues that are all the same type of IT incident.

The agent can be configured to exclusively execute the playbook that is provided to the agent at module 302. Specifically, the agent can be configured to execute the playbook while refraining from executing the playbook. In various embodiments, the playbook and the instructions can be updated or modified by either or both the agent and other agents. As follows, the agent can be constantly configured to execute the playbook as either or both the playbook and the instructions for executing the playbook are changed. For example, other agents that are configured to exclusively update the playbook can modify the playbook. Further, the other agents can modify the instructions for executing the playbook. In turn, the agent can be configured to execute the changing playbook according to the changing playbook instructions.

At module 306, an incident is assigned to the agent (e.g., level 2 agent 206). The incident can be assigned to the agent according to incident assignment rules. Specifically, the incident can be assigned to the agent according to a playbook that is executed by the agent and characteristics of the incident. More specifically, if the incident can be resolved through the playbook that is executed by the agent, e.g. as indicated by characteristics of the incident, then the incident can be assigned to the agent. An incident can be a unique incident with a low chance of occurring again. For example, an incident can be a unique attack launched against an enterprise. Alternatively, an incident can be a frequently occurring incident. For example, an incident can be a routine problem associated with accessing an email account.

When a requester 212 communicates an incident request, the level 2 agent 206 assigned to handle the incident request can be a level 2 agent that has been designated and/or trained as an expert on resolving the particular incident that requester 212 has encountered. Assigning the incident to an agent who is configured to exclusively operate a playbook for resolving the current incident is technically advantageous as it can ensure that the incident is assigned to an agent who has previously resolved the same type of incident as the current incident. In turn, assigning the incident to an experienced agent can help in ensuring that the playbook is properly implemented according to the instructions. As follows, this can promote resolution of the incident and potentially in a more efficient manner, e.g. when compared to an inexperienced agent.

At module 308, the agent (e.g., level 2 agent 206) autonomously executes, based on the instructions, one or more resolution steps of the playbook to attempt to resolve the incident. Specifically, the agent can comprise and execute generative ML models, such as LLMs to execute resolution steps of the playbook according to the instructions. In doing so, the agent can access various tools and knowledge sources. Further, the agent can communicate with various entities, such as human operators, other agents, and the requestor. Leveraging the agent to autonomously execute the playbook is technically advantageous as an organization can conserve resources that would otherwise be spent on a human operator implementing the playbook to resolve the incident.

The agent can implement the playbook in a manner to try to minimize the amount of time it takes for incident resolution, e.g. when compared to a human operator implementing the playbook. Further the agent can implement the playbook while also trying to minimize the amount of communication with the requester, e.g. when compared to a human operator implementing the playbook. In some examples, the agent can only communicate with the requester when necessary (i.e., for approval, for permission/notification to escalate, and consultation). Implementing the playbook to minimize the time for incident resolution and minimize communications with the requestor is technically advantageous as it can conserve resources that can be used by the agent in implementing the playbook.

The agent can exclusively execute the playbook. Specifically, the playbook can be specific to the agent and the agent can only execute the playbook in operating to resolve incidents. Exclusively executing the playbook by an agent is technically advantageous can enable safer-execution of the autonomous AI Agent, since it only has access to Tools mentioned in the Playbook itself (as opposed to generalist AI Agents which will require Tools that relate to a more broad set of needs, and so are more risky). Further, exclusively executing the playbook can simplify the learning/reflection process, making the agent more efficient in reflecting after implementation of the playbook and changing the playbook.

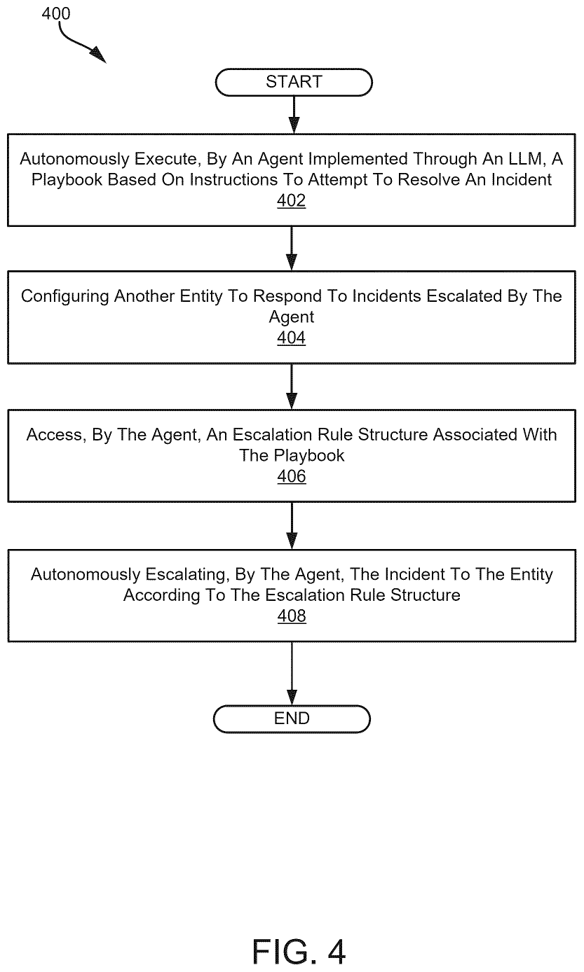

The disclosure now continues with a discussion of escalating incidents to other entities in an organizational structure. Specifically, FIG. 4 illustrates a flowchart 400 of an example method of autonomously escalating an incident through an agent implemented through an LLM, according to some examples of the present disclosure. The method shown in FIG. 4 is provided by way of example, as there are a variety of ways to carry out the method. Additionally, while the example method is illustrated with a particular order of steps, those of ordinary skill in the art will appreciate that FIG. 4 and the modules shown therein can be executed in any order and can include fewer or more modules than illustrated. Each module shown in FIG. 4 represents one or more steps, processes, methods or routines in the method. The modules will be discussed with respect to the example architectures described herein.

At module 402, an agent (e.g., level 2 agent 206) implemented through an LLM, autonomously executes a playbook (e.g., playbook 208) to resolve an incident. Specifically, the agent can execute the playbook in an automated manner based on instructions in order to attempt to resolve the incident. The agent can execute the playbook in resolving the incident after the incident is assigned to the agent. The incident can be assigned to the agent based on the agent being capable of executing the playbook and characteristics of the incident in association with the playbook. Specifically, the incident can be assigned to the agent based on the agent exclusively executing the playbook and characteristics of the incident in relation to the playbook.

At module 404, another entity (e.g., level 3 entity 214) is configured to respond to incidents escalated by the agent (e.g., level 2 agent 206). The entity can be configured to respond to the incident through a playbook. Specifically, the entity can be configured to respond to the incident through the playbook according to instructions for executing the playbook.

In configuring the entity to respond to incidents escalated by the agent, the entity can be configured to access and utilize various tools or separate knowledge sources in gathering information and performing functions for implementing the playbook to resolve the incident. Specifically, the entity can be configured to interact with a requestor associated with the incident, interact with a human operator that is separate from the requestor, interact with another entity, e.g. an agent or operator in an organizational structure, or access a knowledgebase that is separate from the entity, e.g. separate from an enterprise associated with the entity.

Level 3 entity 214 can be considered more expert than level 2 agents 206 and have access to more tools to resolve incidents. The level 3 entity 214 can comprise and execute machine learning (ML) models and large language models (LLMs). Accordingly, the level 3 entity 214 can be implemented as an agent that can function autonomously in attempting to resolve an incident. While functioning autonomously, the level 3 entity can still interact with a human operator in performing functions to attempt to resolve the incident. Further, the level 3 entity 214 can be implemented as a human operator that is configured to attempt to resolve the incident.

In some cases, the level 3 entity 214 can implement research tools to hypothesize on the cause of the incident and can employ various approaches to resolve the incident. A level 3 entity 214 can also determine if there is a different playbook 208 that may resolve the incident, and subsequently assign the incident back to a level 2 agent using the different playbook. Alternatively, level 3 entity 214 can communicate the incident request to a human operator 216 if it is determined that human intervention may be helpful in resolving the incident. (Level 2 agent 206 can also communicate directly to a human operator 216 if it determines that a human operator 216 would be preferable to a level 3 entity 214.).

At module 406, the agent (e.g., level 2 agent 206) accesses an escalation rule structure associated with the playbook. For example, the agent can attempt to resolve the incident by executing a playbook according to instructions, as discussed above. If the incident is not resolved by executing the playbook, then the incident can be escalated and passed onto one an applicable entity (e.g. level 3 entity 214 or human operator 216).

The escalation rule structures, e.g. as part of playbook execution instruction associated with the playbook, can specify applicable rules for an agent to follow in determining whether to escalate and actually escalating an incident to another entity. Specifically, the incident request can be escalated according to a rule structure that specifies to escalate when (1) a requester explicitly asks for a human operator, (2) playbook execution instructions have been exhausted without resolution, (3) frustration detected by sentiment analysis, (4) it is determined an urgent (or VIP) request, (5) the wrong agent is assigned (i.e., out-of-scope issues for rapid handoff), (6) technical errors or timeouts occur, and/or (7) a complex case is recognized that can require human expertise. Additionally, it is understood that an incident request can be escalated to another entity for an applicable reason.

At module 408, the method 400 can include autonomously escalating, by the agent (e.g., level 2 agent 206), the incident to the entity (e.g., level 3 entity 214) according to the escalation rule structure. Specifically, the agent can follows escalation rules in escalating the incident and passing the incident onto the entity. For example, the policy can specify escalating the incident if the requestor explicitly asks to direct the incident to a human, if there is no known next step to apply in attempting to resolve the incident, or the incident is approaching an SLA break. Providing an agent the ability to autonomously escalate the incident is technically advantageous as resources that would otherwise be spent by a human operator in determining whether to escalate the incident can be conserved. Further, as the agent follows an escalation rule structure without any human intervention, any bias that might be introduced by a human operator in deciding whether the escalate the incident can be eliminated. In turn, this can promote a more efficient resolution of the incident, e.g. through escalation to another entity.

The incident can be escalated, at module 408, to an entity that is another agent, e. g, a level 3 agent. The agent can be implemented through a generative ML model, such as an LLM and configured to autonomously resolve the escalated incident. Specifically, the agent can be configured to autonomously execute a playbook in attempting to resolve the escalated incident. The playbook can be tailored for the agent. Specifically, the playbook can be tailored to resolving an escalated incident through an entity that is higher in a hierarchical organizational structure, e.g. a level 3 agent as opposed to a level 2 agent. For example, the playbook can specify accessing and analyzing logs of past incidents to attempt to resolve the incident. Implementing an agent that is configured to autonomously resolve an escalated incident is technically advantageous as resources that would otherwise be spent in resolving the escalated incident through a human operator can conserved.

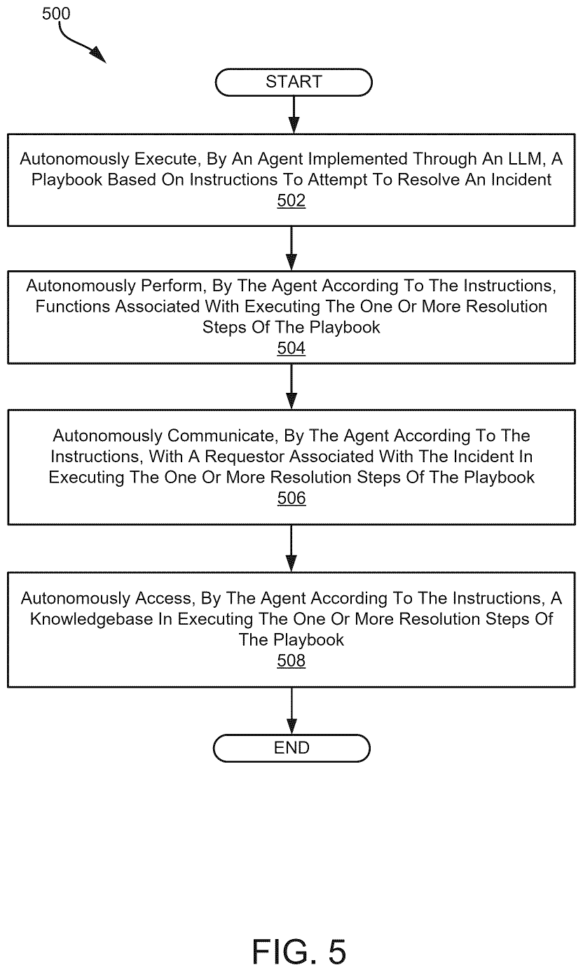

The disclosure now continues with a more detailed description of how an agent can be implemented to autonomously execute a playbook. FIG. 5 illustrates a flowchart 500 of an example method of autonomously performing operations through an agent in implementing a playbook to attempt to resolve an incident, according to some examples of the present disclosure. The method shown in FIG. 5 is provided by way of example, as there are a variety of ways to carry out the method. Additionally, while the example method is illustrated with a particular order of steps, those of ordinary skill in the art will appreciate that FIG. 5 and the modules shown therein can be executed in any order and can include fewer or more modules than illustrated. Each module shown in FIG. 5 represents one or more steps, processes, methods or routines in the method. The modules will be discussed with respect to the example architectures described herein.

At module 502, the method 500 includes autonomously executing a playbook, by an agent (e.g., level 2 agent 206) implemented through an LLM, based on instructions for implementing the playbook to attempt to resolve an incident. For example, when a requester communicates an incident request, the incident can be assigned to the agent. In turn, the agent can follow instructions for implementing the playbook to attempt to resolve the incident through the playbook.

At module 504, the agent can autonomously perform, according to the instructions, functions for implementing the resolution steps of the playbook. Functions for implementing the resolution steps of the playbook can comprise applicable functions that can be performed in achieving the resolution steps. Specifically, functions for implementing the resolution steps can comprise functions that are distinct from communicating with a requestor and accessing a knowledgebase to attain additional information in attempting to resolve the incident through the playbook. For example, the functions performed by the agent can comprise unlocking an account and troubleshooting issues that caused the account to lock.

At module 506, the agent can autonomously communicate, according to the instructions, with a requestor associated with the incident in executing the one or more resolution steps of the playbook. In some cases, the agent can autonomously communicate with the requester in order to help resolve the incident. Further, in some examples, the agent can only communicate with the requester when necessary (i.e., for approval, for permission/notification to escalate, and consultation).

At module 508, the agent can autonomously access, according to the instructions, a knowledgebase in executing the one or more resolution steps of the playbook. Specifically, the playbook can specify accessing a knowledgebase to resolve an issue if certain conditions are met, as part of a resolution step. Further, the instructions can specify analyzing the information gathered from the knowledgebase and trying to resolve the incident based on such analysis. In turn, the agent can analyze information gathered from the knowledgebase in attempting to resolve the incident.

As described with respect to the flowchart 500, each of the modules 502, 504, 506, and 508 can be performed autonomously in attempting to resolve the incident through the playbook. By leveraging agents to autonomously execute the playbook, an organization can conserve resources that would otherwise be spent on a human operator implementing the playbook to resolve the incident. Specifically, configuring an agent to autonomously execute the playbook, autonomously perform functions associated with executing the playbook, autonomously communicate with the requestor associated with the incident, and autonomously accessing a knowledgebase in executing the playbook to resolve the incident is technically advantageous as an organization can conserve resources that would otherwise be spent on a human operator implementing the playbook to resolve the incident. Further, playbook execution can come down to helping the requestor with knowledge access (personal information such as order status, general information such as policy inquiries, etc.). Generative models, such as LLMs, excel in knowledge retrieval and summarization over a very large corpus, whereas this task is challenging for a human.

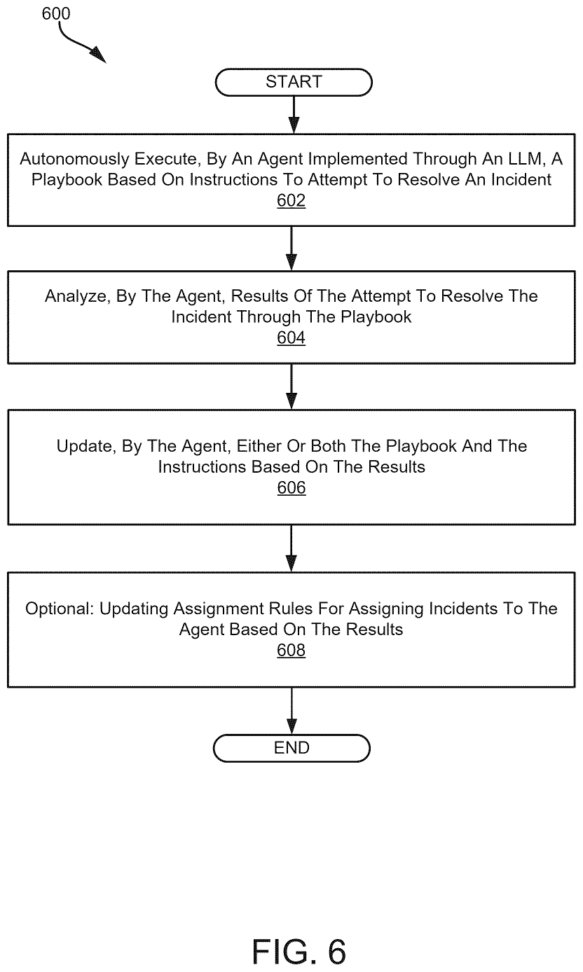

The description now continues with a discussion of the agent autonomously analyzing and making changes in association with execution of the playbook. Specifically, FIG. 6 illustrates a flowchart 600 of an example method of an autonomous agent analyzing execution of a playbook and making modifications to the playbook or instructions for executing the playbook, according to some examples of the present disclosure. The method shown in FIG. 6 is provided by way of example, as there are a variety of ways to carry out the method. Additionally, while the example method is illustrated with a particular order of steps, those of ordinary skill in the art will appreciate that FIG. 6 and the modules shown therein can be executed in any order and can include fewer or more modules than illustrated. Each module shown in FIG. 6 represents one or more steps, processes, methods or routines in the method. The modules will be discussed with respect to the example architectures described herein.

At module 602, an agent (e.g., level 2 agent 206) implemented through an LLM, can autonomously execute a playbook (e.g., playbook 208), based on instructions, to attempt to resolve an incident. Specifically, the incident can be assigned to the agent for resolution. Further, the agent can be configured to implement the playbook in resolving incidents. As follows, the agent can autonomously implement the playbook to attempt to resolve the incident.

At module 604, the agent can analyze results of the attempt to resolve the incident through the playbook. For example, the agent can analyze the results to learn and improve their ability to resolve incidents by implementing the playbook. Improving incident resolution can include reducing time and/or resources necessary and/or improving the success rate of the resolution. Improving resolving incidents can also include reducing communication and/or effort on the part of the requester with the agent. Upon completion of an incident request (whether successful or not), the agent can record a reflection. A reflection can include data and information related to an incident and the attempted resolution of that incident that can be helpful in improving further resolution attempts. The agents can then analyze these stored reflections to identify improvement opportunities in implementing the playbook. The agent can also improve their ability to resolve incidents by analyzing direct feedback from requesters and human operator. The agents can analyze any data or information available to improve their ability to resolve incidents.

At module 606, the agent can modify either or both the playbook and the instructions based on the results. For example, by analyzing the reflection data (and any other available data and/or information), the agent can rapidly identify and deflect incorrectly assigned incidents; re-order one or more steps of the playbook execution instructions; suggest one or more new steps for playbook execution instructions; and/or remove and/or modify any steps within the playbook execution instructions (such as, for example, a step determined to be ineffective).

At module 608, the flowchart 600 can optionally include updating assignment rules for assigning incidents to the agent based on the results. Specifically, not only can improvements be made to the playbook and/or the playbook execution instructions, but the agent can also refine the process for assignment of incidents to agents. In some cases, a different agent may be more suited (i.e., more of an expert) to resolving an incident than the originally assigned agent. Additionally, the agent can also modify the escalation pathway (i.e., when and where to communicate an incident request for escalation) based on the reflections or any other gathered information or data.

The analysis of the playbook execution can be performed autonomously by the agent. As follows, the agent can make suggestions to change one or a combination of the playbook, the playbook execution instructions, the assignment rules, and the escalation rules. Configuring the agent to autonomously analyze the playbook execution in attempting to resolve the incident is technically advantageous as human resources that would be directed to a human operator analyzing the playbook can be conserved. As follows, one or a combination of the playbook, the playbook execution instructions, the assignment rules, and the escalation rules can be modified based on the analysis of the running of the playbook. This is technically advantageous as human resources that would otherwise be used in performing these refinements through a human operator can be conserved. Additionally, any bias in performing these refinements that is introduced through a human operator can be elimination or mitigated.

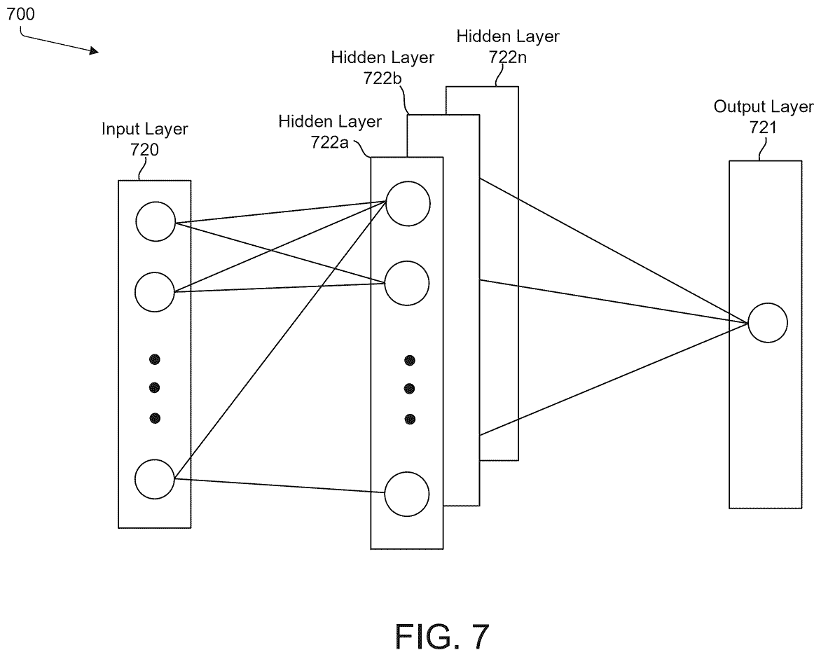

In FIG. 7, the disclosure now turns to a further discussion of models that can be used to implement the technology described herein. FIG. 7 is an example of a deep learning neural network 700 that can be used to implement all or a portion of the systems and techniques described herein, according to some examples of the present disclosure. An input layer 720 can be configured to receive input data. Neural network 700 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. Neural network 700 further includes an output layer 721 that provides an output resulting from the processing performed by the hidden layers 722a, 722b, through 722n.

Neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the first hidden layer 722a can transform the information of each input node by applying activation functions to the input node information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 721, at which an output is provided. In some cases, while nodes in the neural network 700 are shown as having multiple output lines, a node can have a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a, 722b, through 722n in order to provide the output through the output layer 721.

In some cases, the neural network 700 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 700 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(1/2(target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 700 can perform a backward pass by determining which inputs (weights) most contributed to the loss of the network, and can adjust the weights so that the loss decreases and is eventually minimized.

The neural network 700 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 700 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

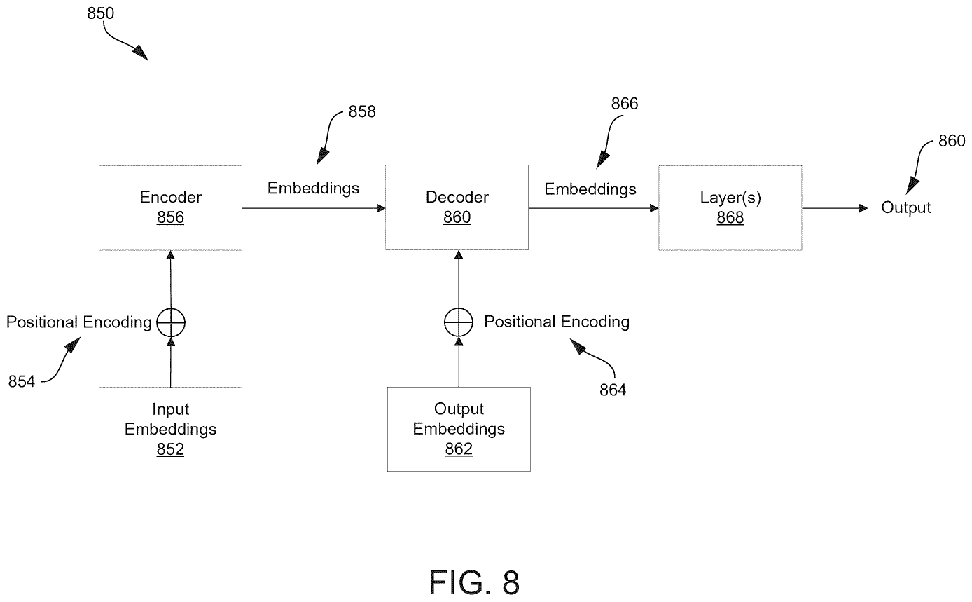

FIG. 8 is a diagram illustrating an example architecture of an example transformer model 850, according to some examples of the present disclosure. The transformer model 850 can be used to implement an LLM that can be used to implement the technology described herein. As shown, the transformer model 850 can include input embeddings 852 used as inputs to the transformer model 850. The input embeddings 852 can include input values representing words and/or sentences, such as numbers or vectors representing words and/or sentences.

In some cases, the input embeddings 852 can function like a dictionary that helps the transformer model 850 understand the meaning of words by placing them in an embedding space where similar words are located near each other. In some examples, the input interface 134 can be trained and/or configured to create the input embeddings 852 so that similar vectors represent words with similar meanings. In some examples, the transformer model 850 can additionally or alternatively learn to create and/or process the input embeddings 852 during training.

The transformer model 850 can use positional encoding 854 to encode the position of each word in an input sequence from the input embeddings 852 as values such as a set of numbers, a vector, etc. The values generated by the positional encoding 854 can be fed into the transformer model 850 along with the input embeddings 852. By incorporating the positional encoding 854 into the transformer model 850, the transformer model 850 can more effectively understand the order of words in a sentence and generate grammatically correct and semantically meaningful output.

The transformer model 850 can include an encoder(s) 856 used to process the positionally encoded input embeddings 852 and generate embeddings 858. The encoder(s) 856 can be part of the transformer model 850 that processes input text and generates hidden states that capture the meaning and context of the text. For example, the encoder(s) 856 can include a feed-forward neural network that is part of the transformer model 850. In some examples, the encoder(s) 856 can implement multiple encoder layers. In some cases, the encoder(s) 856 can first tokenize the input text into a sequence of tokens, such as individual words or subwords. The encoder(s) 856 can then apply one or more self-attention layers, which can generate hidden states that represent the input text at different levels of abstraction. In this way, the encoder(s) 856 can generate the embeddings 858 (e.g., a vector, a set of values, etc.) representing the semantics and position of words in one or more sentences.

The transformer model 850 can include output embeddings 862, which can include values representing words and/or sentences, such as numbers or vectors representing words and/or sentences. The output embeddings 862 can be similar to the input embeddings 852 and can also be processed by positional encoding 864 to encode the position of each word in a sequence from the output embeddings 862 as values such as a set of numbers, a vector, etc., which helps the transformer model 850 understand the order of words in a sentence. The output embeddings 862 can be used during a training phase of the transformer model 850 and can be used during an inference phase. During training, a loss function can be computed based on the output embeddings 862 and used to update the model parameters to improve the accuracy of the transformer model 850. During an inference phase, the output embeddings 862 can be used to generate the output text by mapping the predicted probabilities determined by the transformer model 850 for each token to the corresponding token in the vocabulary.

The positionally encoded input embeddings 852 (e.g., the embeddings 858) and the positionally encoded output embeddings 862 can be fed to a decoder(s) 860 used to generate the output sequence based on the encoded input sequence. During training, the decoder(s) 860 can learn how to guess the next word of a sequence by looking at the words before it. In some examples, the decoder(s) 860 can generate natural language text based on the input sequence and any learned context.

The decoder(s) 860 can generate embeddings 866 and feed the embeddings 866 to one or more network layers 868. In some examples, the one or more network layers 868 can include a linear layer and a softmax function. The linear layer can map the embeddings 866 generated by the decoder(s) 860 to a higher-dimensional space, which can transform the embeddings 866 into the original input space. The softmax function can then be applied to generate a probability distribution for each output token in the vocabulary, which can result in an output 870. In some examples, the output 870 can include output tokens with probabilities.

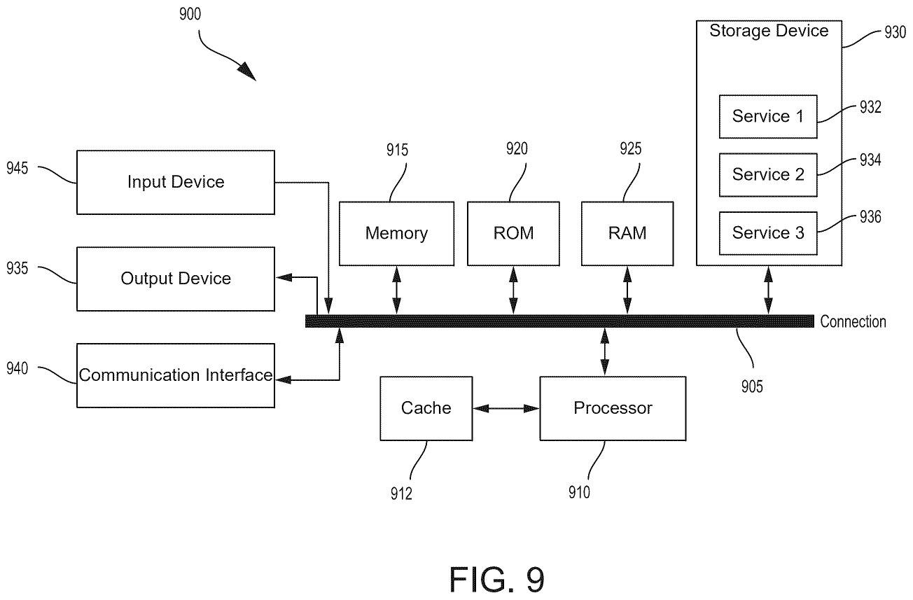

FIG. 9 illustrates an example processor-based system with which some embodiments of the subject technology can be implemented. For example, processor-based system 900 can be any computing device making up, or any component thereof in which the components of the system are in communication with each other using connection 905. Connection 905 can be a physical connection via a bus, or a direct connection into processor 910, such as in a chipset architecture. Connection 905 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 900 includes at least one processing unit (Central Processing Unit (CPU) or processor) 910 and connection 905 that couples various system components including system memory 915, such as Read-Only Memory (ROM) 920 and Random-Access Memory (RAM) 925 to processor 910. Computing system 900 can include a cache of high-speed memory 912 connected directly with, in close proximity to, or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms known to those of skill in the art. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 930 can include software services, servers, services, etc., that when the code that defines such software is executed by the processor 910, it causes the system 900 to perform a function. In some embodiments, a hardware service that performs a particular function can include the software component stored in a computer-readable medium in connection with the necessary hardware components, such as processor 910, connection 905, output device 935, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Illustrative Examples of the Disclosure Include:
Embodiment 1. A computer-implemented method comprising: providing, to an agent implemented through a large language model (LLM), a playbook in a form that is perceivable by the LLM; configuring, based on instructions, the agent to execute the playbook to resolve one or more incidents; assigning an incident to the agent; and autonomously executing, by the agent, one or more resolution steps of the playbook based on the instructions to attempt to resolve the incident.
Embodiment 2. The computer-implemented method of Embodiment 1, wherein the instructions specify, during execution of the playbook, accessing a knowledgebase in attempting to resolve the incident, wherein the agent is configured to access the knowledgebase.
Embodiment 3. The computer-implemented method of either Embodiment 1 or 2, wherein the instructions specify one or more rules for communicating with a requestor associated with the incident in attempting to resolve the incident by executing the playbook, the method further comprising configuring the agent to communicate with the requestor according to the one or more rules.
Embodiment 4. The computer-implemented method of any of Embodiments 1 through 3, wherein the instructions specify autonomously performing a function associated with executing the one or more resolution steps of the playbook, the method further comprising configuring the agent to autonomously perform the function.
Embodiment 5. The computer-implemented method of any of Embodiments 1 through 4, wherein the instructions specify an escalation rule structure for escalating the incident, the method further comprising configuring the agent to control escalation of the incident according to the escalation rule structure.
Embodiment 6. The computer-implemented method of Embodiment 5, wherein the agent implemented through the LLM is a first agent at a first hierarchical level in an organizational hierarchy and escalating the incident comprises transmitting the incident to an entity at a second hierarchical level in the organizational hierarchy.
Embodiment 7. The computer-implemented method of Embodiment 6, wherein the entity at the second hierarchical level is a human operator.
Embodiment 8. The computer-implemented method of Embodiment 6, wherein the entity at the second hierarchical level is a second agent implemented through the LLM.
Embodiment 9. The computer-implemented method of Embodiment 8, further comprising configuring the second agent to exclusively respond to escalated incidents in a domain associated with the incident according to resolution instructions.
Embodiment 10. The computer-implemented method of any of Embodiments 1 through 9, further comprising: analyzing, by the agent, results of the attempt to resolve the incident by executing the one or more resolution steps of the playbook based on the instructions; and updating, by the agent, either or both the playbook and the instructions for resolving incidents through the playbook based on the results.
Embodiment 11. The computer-implemented method of Embodiment 10, further comprising updating, by the agent based on the results, a function specified by the instructions and associated with executing the one or more resolution steps of the playbook, an escalation rule structure specified by the instructions for escalating the incident to another agent, or a combination thereof.
Embodiment 12. The computer-implemented method of either Embodiment 10 or 11, further comprising updating the playbook by the agent based on the results comprising: modifying the one or more resolution steps in the playbook; adding one or more additional resolution steps in the playbook; changing an order of the one or more resolution steps in the playbook; or a combination thereof.
Embodiment 13. The computer-implemented method of any of Embodiments 1 through 12, wherein the incident is assigned to the agent according to assignment rules for the agent executing the playbook and characteristics or the incident.
Embodiment 14. The computer-implemented method of Embodiment 13, further comprising: analyzing, by the agent, results of the attempt to resolve the incident by executing the one or more resolution steps of the playbook based on the instructions; and updating, by the agent, the assignment rules for the agent executing the playbook based on the results.
Embodiment 15. A system comprising: one or more processors; and at least one computer-readable storage medium having stored therein commands which, when executed by the one or more processors, cause the one or more processors to: provide, to an agent implemented through a large language model (LLM), a playbook in a form that is perceivable by the LLM; configure, based on instructions, the agent to execute the playbook to resolve one or more incidents; assign an incident to the agent; and autonomously execute, by the agent, one or more resolution steps of the playbook based on the instructions to attempt to resolve the incident.
Embodiment 16. The system of Embodiment 15, wherein the instructions specify an escalation rule structure for escalating the incident, the method further comprising configuring the agent to control escalation of the incident according to the escalation rule structure.
Embodiment 17. The system of Embodiment 16, wherein the agent implemented through the LLM is a first agent at a first hierarchical level in an organizational hierarchy and escalating the incident comprises transmitting the incident to an entity at a second hierarchical level in the organizational hierarchy.
Embodiment 18. The system of Embodiment 17, wherein the entity at the second hierarchical level is a second agent implemented through the LLM.
Embodiment 19. The system of any of Embodiments 15 through 18, wherein the commands further cause the one or more processors to: analyze, by the agent, results of the attempt to resolve the incident by executing the one or more resolution steps of the playbook based on the instructions; and update, by the agent, either or both the playbook and the instructions for resolving incidents through the playbook based on the results.
Embodiment 20. A non-transitory computer-readable storage medium storing instructions for causing one or more processors to: provide, to an agent implemented through a large language model (LLM), a playbook in a form that is perceivable by the LLM; configure, based on instructions, the agent to execute the playbook to resolve one or more incidents; assign an incident to the agent; and autonomously execute, by the agent, one or more resolution steps of the playbook based on the instructions to attempt to resolve the incident.
Embodiment 21. A system comprising means for performing a method according to any of Embodiments 1 through 14.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computer-implemented method comprising:
providing, to an agent implemented through a large language model (LLM), a playbook in a form that is perceivable by the LLM;
configuring, based on instructions, the agent to execute the playbook to resolve one or more incidents;
assigning an incident to the agent; and
autonomously executing, by the agent, one or more resolution steps of the playbook based on the instructions to attempt to resolve the incident.

2. The computer-implemented method of claim 1, wherein the instructions specify, during execution of the playbook, accessing a knowledgebase in attempting to resolve the incident, wherein the agent is configured to access the knowledgebase.

3. The computer-implemented method of claim 1, wherein the instructions specify one or more rules for communicating with a requestor associated with the incident in attempting to resolve the incident by executing the playbook, the method further comprising configuring the agent to communicate with the requestor according to the one or more rules.

4. The computer-implemented method of claim 1, wherein the instructions specify autonomously performing a function associated with executing the one or more resolution steps of the playbook, the method further comprising configuring the agent to autonomously perform the function.

5. The computer-implemented method of claim 1, wherein the instructions specify an escalation rule structure for escalating the incident, the method further comprising configuring the agent to control escalation of the incident according to the escalation rule structure.

6. The computer-implemented method of claim 5, wherein the agent implemented through the LLM is a first agent at a first hierarchical level in an organizational hierarchy and escalating the incident comprises transmitting the incident to an entity at a second hierarchical level in the organizational hierarchy.

7. The computer-implemented method of claim 6, wherein the entity at the second hierarchical level is a human operator.

8. The computer-implemented method of claim 6, wherein the entity at the second hierarchical level is a second agent implemented through the LLM.

9. The computer-implemented method of claim 8, further comprising configuring the second agent to exclusively respond to escalated incidents in a domain associated with the incident according to resolution instructions.

10. The computer-implemented method of claim 1, further comprising:
analyzing, by the agent, results of the attempt to resolve the incident by executing the one or more resolution steps of the playbook based on the instructions; and
updating, by the agent, either or both the playbook and the instructions for resolving incidents through the playbook based on the results.

11. The computer-implemented method of claim 10, further comprising updating, by the agent based on the results, a function specified by the instructions and associated with executing the one or more resolution steps of the playbook, an escalation rule structure specified by the instructions for escalating the incident to another agent, or a combination thereof.

12. The computer-implemented method of claim 10, further comprising updating the playbook by the agent based on the results comprising:
modifying the one or more resolution steps in the playbook;
adding one or more additional resolution steps in the playbook;
changing an order of the one or more resolution steps in the playbook; or
a combination thereof.

13. The computer-implemented method of claim 1, wherein the incident is assigned to the agent according to assignment rules for the agent executing the playbook and characteristics or the incident.

14. The computer-implemented method of claim 13, further comprising:
analyzing, by the agent, results of the attempt to resolve the incident by executing the one or more resolution steps of the playbook based on the instructions; and
updating, by the agent, the assignment rules for the agent executing the playbook based on the results.

15. A system comprising:
one or more processors; and
at least one computer-readable storage medium having stored therein commands which, when executed by the one or more processors, cause the one or more processors to:
provide, to an agent implemented through a large language model (LLM), a playbook in a form that is perceivable by the LLM;
configure, based on instructions, the agent to execute the playbook to resolve one or more incidents;
assign an incident to the agent; and
autonomously execute, by the agent, one or more resolution steps of the playbook based on the instructions to attempt to resolve the incident.

16. The system of claim 15, wherein the instructions specify an escalation rule structure for escalating the incident, the method further comprising configuring the agent to control escalation of the incident according to the escalation rule structure.

17. The system of claim 16, wherein the agent implemented through the LLM is a first agent at a first hierarchical level in an organizational hierarchy and escalating the incident comprises transmitting the incident to an entity at a second hierarchical level in the organizational hierarchy.

18. The system of claim 17, wherein the entity at the second hierarchical level is a second agent implemented through the LLM.

19. The system of claim 16, wherein the commands further cause the one or more processors to:
analyze, by the agent, results of the attempt to resolve the incident by executing the one or more resolution steps of the playbook based on the instructions; and
update, by the agent, either or both the playbook and the instructions for resolving incidents through the playbook based on the results.

20. A non-transitory computer-readable storage medium storing instructions for causing one or more processors to:
provide, to an agent implemented through a large language model (LLM), a playbook in a form that is perceivable by the LLM;
configure, based on instructions, the agent to execute the playbook to resolve one or more incidents;
assign an incident to the agent; and
autonomously execute, by the agent, one or more resolution steps of the playbook based on the instructions to attempt to resolve the incident.
